(19) United States
(12) Patent Application Publication
(10) Pub. No.: US 2015/0274537 A1
(43) Pub. Date: Oct. 1, 2015

(54) DRY ICE DISPENSING APPARATUS

(71) Applicant: JetChill Ltd, Newcastle (GB)

(72) Inventors: Colin Myers, Heighington Village (GB); Robert Flunder, London (GB)

(21) Appl. No.: 14/669,690

(22) Filed: Mar. 26, 2015

(30) Foreign Application Priority Data
Mar. 26, 2014 (GB) 1405431.6

(51) Int. Cl. C01B 31/22

(52) U.S. Cl. CPC C01B 31/22

(57) ABSTRACT

The present invention provides for dry-ice dispensing including a nozzle arranged to receive liquid carbon dioxide at an inlet and to apply a decrease in pressure to the liquid carbon dioxide for delivery of carbon dioxide gas at an outlet and for forming dry-ice, the said nozzle having a passageway extending from the inlet to the outlet and configured to increase the pressure of the liquid carbon dioxide received at the inlet prior to applying the said pressure decrease, and also a dry-ice delivery tube arranged to receive carbon dioxide gas and liquid carbon dioxide from a dry-ice delivery nozzle and having an elongate passageway configured to at least part-control formation of a carbon dioxide gas phase and for controlled formation of dry-ice within the tube and a dry-ice delivery diffuser having a delivery aperture through which carbon dioxide gas and dry ice can be delivered to a target receptacle from a delivery tube, and the diffuser having venting apertures dimensioned to control escape of carbon dioxide gas from the target receptacle, and thus to control pressure within the target receptacle.

### BACKGROUND

The present application relates to apparatus for dispensing carbon dioxide (CO₂) dry ice and in particular, but not exclusively, to apparatus for dispensing dry ice into one or more suitably-constructed drinking vessels or glasses.

A system for dispensing dry ice into a drinking vessel is described in published International patent application WO2008/045802A2. The system allows for the delivery of dry ice into a single drinking vessel pre-configured to include a chamber into-which the dry ice is delivered and which remains in fluid communication, by way of perforations, with the remainder of the interior of the vessel. However, the perforations are adapted to retain the dry ice within the chamber. The intention is that, once charged with dry ice, the vessel then receives a beverage which, by way of the fluid communication, passes into the chamber to fill the same before further filling the vessel. The contact between the dry ice and the beverage causes sublimation of the dry ice and so CO2 gas bubbles-up through the beverage and upon escaping at the surface mixes with the warmer air above the beverage causing a marked drop in temperature and thus the formation of a fog-effect as is well known.

The known system also comprises a charging apparatus which comprises a body for holding a filter in engagement with at least one of the perforations of the dry ice chamber of the vessel. Liquid CO2 is discharged from a pressure vessel through an electrically operated valve and into the charging apparatus. Such discharge into the charging apparatus is accompanied by a pressure drop which, as is well known, causes vaporization of some of the liquid CO2 which in-turn drastically reduces the temperature of the remaining liquid CO2 which solidifies into dry ice which is intended to be captured and retained within the dry ice chamber of the vessel. The dry ice is prevented from leaving the dry ice chamber by means of the above-mentioned filter, but which filter allows carbon dioxide gas, and any other gas in the chamber, to vent and so escape from the chamber.

However, it has now been identified that such know systems exhibit various limitations and disadvantages. For example, following initial switch-on, known systems can produce too much gas prior to creation of the dry ice. This can arise for various reasons including the configuration of the conduit (hose and/or pipe work) from the supply cylinder through to the nozzles. For example this can be such as to cause pressure changes of the CO₂ gas which means that initially it can prove necessary to pass several litres of CO₂ gas through the piping to lower the ambient temperature to a value suitable to produce dry ice.

Also, once dry ice is produced, the pressure in the dry ice drinking vessel can decreases very quickly which can resulting in the dry ice reverting back to its gaseous form and then causing either very slow filling of the dry ice chamber, only the filling of only a portion of the dry ice chamber during a particular delivery time period. Such known systems can therefore exhibit a significant wastage of CO2 product during the formation of dry ice. Another undesirable consequence is increased time required to charge a vessel with dry ice.

Further, such known systems employ a diffuser-based system incorporating a sintered disk acting as a back-pressure regulation valve to retain pressure, and thus dry ice, within the dry ice chamber of the vessel. While this can work well when new, over time the sinted disk becomes corroded due to the formation of carbonic acid a by-product of CO2 gas and moisture in the air. As the disk becomes more and more corroded, it will eventually fail due to it becoming blocked. Once this happens the back-pressure in the vessel can become so great, as more gas and dry ice is delivered, it could cause a system failure and catastrophic failure of the working system parts, rendering the system in-operable.

Yet further, various means and methods for converting the liquid CO2 from its liquid phase into its gas phase are disclosed by way of the known systems and which employ variations comprising either a carburettor injector connected to a length of delivery-pipe, or a spark-eroded tube with differing diameters. While the required CO2 gas can be formed by way of both of these systems, they are disadvantageously difficult to control.

### SUMMARY

The present invention therefor seeks to provide for dry ice dispensing apparatus and systems having advantages over known such apparatus and systems.

According to one aspect of the present invention there is provided a dry-ice supply nozzle arranged to receive liquid carbon dioxide at an inlet and to apply a decrease in pressure to the liquid carbon dioxide for delivery of carbon dioxide gas at an outlet and for forming dry-ice, the said nozzle having a passage extending from the inlet to the outlet and configured to increase the pressure of the liquid carbon dioxide received at the inlet prior to applying the said pressure decrease.

The nozzle can prove particularly advantageous in the eventual formation of the appropriate density of dry-ice which, advantageously, takes the form of dry-ice snow.

In one particular arrangement, the passage can include a compression region for applying the said increase in pressure. In particular, the passage can comprise a cylindrical passageway.

Further preferred features of the present invention can comprise configuration of the passage so as to provide a two-stage, and generally sequential, increase in pressure of the liquid carbon dioxide.

In this manner, the passage of the nozzle can include first and second compression regions in communication in series in the direction of travel of the carbon dioxide through the nozzle.

In particular, the second compression region can have at least one dimension, smaller than the corresponding dimension of the first compression region.

In a particular example, the said second compression region can have a smaller diameter than the said first compression region.

According to one particular advantageous embodiment of the invention, the said first and second compression regions comprise first and second cylindrical chambers in fluid communication.

Yet further, the said first and second compression regions can be configured on a common axis extending in the direction of the travel of the carbon dioxide through the nozzle.

In this manner, the said first and second compression regions can be located co-axially.

As further detail of a particular embodiment of the present invention, there is provided a transmission region from the first compression region to the second compression region, the transmission region being defined by a wall portion inclined to the direction of travel of the carbon dioxide through the nozzle.

Yet further, the wall portion of the transition region can comprise a planar wall portion.

In one particular example, the said angle of inclination of the wall portion of the transition region relative to the said direction of travel of carbon dioxide through the nozzle is at, or in the region of, 45 degrees.

The wall portion of the transition region can comprise a frusto-conical portion of an inner wall of the said passage.

Still further, the nozzle can include a transition region from the said second compression region to the region of the nozzle outlet and comprising a further wall portion inclined to the said direction of travel of the carbon dioxide.

As regards the transition region between the second compression region and the region of the nozzle outlet, this can include the same configuration features as that of the above mentioned transition between the first and second compression regions. That is, the wall portion can comprise a planar wall portion and the angle inclination to the said direction of travel can be at, or in the region of 45 degrees. Again, the wall portion can be formed by frusto-conical portion of an inner wall of the passageway.

The nozzle advantageously includes an expansion portion in the region of its outlet which includes a wall portion inclined to the said direction of travel of the carbon dioxide.

As with the transition regions noted above, the expansion portion can include a planar wall portion inclined to the said direction of travel and angle of inclination to the said direction of travel of carbon dioxide can be at, or about 45 degrees.

Again, the wall portion can be formed by frusto-conical portion of the passageway and with the walls of the cone portion extending at a mutual angle at, or in the region of 90 degrees.

One particular arrangement, the said expansion portion is separated from the said second compression region by a narrow cylindrical bore.

According to another aspect of the present invention there is provided a dry-ice delivery tube arranged to receive carbon dioxide gas and liquid carbon dioxide from a dry-ice delivery nozzle and having an elongate passage configured to at least part-control formation of a carbon dioxide gas phase and for controlled formation of dry-ice within the tube.

Preferably, the dry-ice is formed towards an end of the tube arranged to be remote from the said delivery nozzle.

Also, the delivery tube is provided with an outlet arranged for delivering dry-ice into a target receptacle.

The delivered tube advantageously defines a passage which can comprise an elongate bore which, preferably, is of uniform width.

In particular, the elongate bore can comprise a cylindrical bore and preferably of uniform diameter.

As a particular example, the delivery tube can be arranged with an opening to receive at least part of a dry-ice supply nozzle in a male/female cooperating fit.

Of course, the delivery tube can be arranged to cooperate with a dry ice supply nozzle as outlined above.

According to a yet further aspect of the present invention there is provided a dry-ice delivery diffuser having a delivery aperture through-which carbon dioxide gas and dry ice can be delivered to a target receptacle from a delivery tube, and the diffuser having venting apertures dimensioned to control escape of carbon dioxide gas from the target receptacle, and thus to control pressure within the target receptacle.

Preferably, the venting apertures are arranged to cooperate with apertures formed in a wall portion of the target receptacle.

Yet further, the venting apertures can comprise a first series of apertures located around the said delivery aperture.

Yet further, the said venting apertures can comprise a second series of venting apertures spaced from the said first series.

In particular, both the first and second series can define respective circular paths

In particular, the said circular paths can be co-axial with the said delivery aperture.

In one arrangement, the said second series of apertures can be provided as recess segments at the outer periphery of the diffuser.

In one particular arrangement, the diffuser is formed of a non-metallic material.

In particular, the diffuser can be formed of a plastic material.

As will be appreciated, the diffuser can be arranged to cooperate with a dry-ice delivery tube.

In particular, the diffuser can be arranged to be mounted on, or to engage with, a dry-ice delivery tube.

In one example, the diffuser is formed integrally with a dry-ice delivery tube.

It will of course be appreciated that the present invention can comprise a dry-ice delivery device comprising a combination of any two or more of the above mentioned supply nozzle, delivery tube and diffuser.

Yet further, the present invention can provide for dry-ice delivery apparatus including at least one dry-ice delivery device and as outlined above.

Preferably, the said apparatus comprises a pair of dry-ice delivery devices as outline above.

According to still a further aspect of the present invention there is provided a method of supplying dry-ice to a target receptacle and including the steps of receiving liquid carbon dioxide from a pressurized source, increasing the pressure of the liquid carbon dioxide prior to the step of decreasing the pressure thereof and for the transition of liquid carbon dioxide to carbon dioxide gas and the subsequent formation of dry-ice.

Preferably, the step of increasing the pressure of the dry-ice comprises a two stage procedure with the pressure increasing from a first level to a second level, and then from the second level to a third level.

It should be appreciated that the exact pressure in the said first, second and third levels may not be constant although the relative levels should increase by a sufficient amount from the first level to the second level, and subsequently from the second level to the third level.

Advantageously, step of increasing the pressure includes delivery of the liquid carbon dioxide into, and travel along a conduit of decreasing dimension in the direction of flow of the carbon dioxide through the conduit.

In this manner, the decrease in dimension is employed to separate the two pressure increase stages.

The method can further include delivery of carbon dioxide gas and liquid carbon dioxide into a delivery tube for formation of the dry-ice therein.

Still further, the method can include the delivery of carbon dioxide gas and dry-ice from the delivery tube into a target receptacle.

Yet further, the method can include such delivery into a target receptacle by way of a diffuser by means of which a step of venting escape of carbon dioxide gas from the receptacle is provided.

The invention is advantageous in providing for more efficient injection of carbon dioxide into a drinking vessel, delivery of plural charges to plural respective drinking vessels, and easier automation of the process of dispensing carbon dioxide into the drinking vessels.

It will be appreciated from the above that the present invention exhibits a variety of advantages in relation to the formation of dry-ice and, in particular, the delivery of dry-ice into a target receptacle, in an efficient and controlled manner.

The two stage compression proves particularly advantageous in order to achieve the appropriate dry ice structure and density within the target receptacle and the provision of two compression chambers of decreasing dimensions in the manner outlined can prove advantageous in maintaining the appropriate Lambda-flow through the compression stages.

The provision of the inclined wall portions proves advantageous in preventing the liquid carbon dioxide to break out too early as a gas during the transition through the nozzle.

The increase in pressure of the liquid carbon dioxide by way of a controlled manner to a level higher than the supply pressure advantageously allows for greater, more improved and more efficient expansion at the outlet of the nozzle.

As regards the delivery tube, the relationship of the internal bore and length of the delivery tube is important since if, too small and too short, dry-ice may form too early and fill the bore of the delivery tube causing a blockage. Alternatively, if the dimensions of the delivery tube are such that the internal bore is too large and too long, formation of dry-ice may only occur once the gas phase exits the delivery tube and enters the target receptacle. This can prove disadvantageous in forming dry-ice at a density that exhibits a powdery characteristic not suited to subsequent use within the target receptacle.

The provision of a plastic diffuser as outline above, and the size and spacing of the apertures noted prove advantageous when compared with known sinted filter discs of known machines insofar as blockage can be prevented as indeed can potential corrosion.

Further advantage is gained if the diameter reduces at one or more locations between the source of the carbon dioxide and the input to the vessel.

### BRIEF DESCRIPTION OF THE DRAWINGS

The invention is described further hereinafter, by way of example only, with reference to the accompanying drawings in which:

FIG. 1 is a front view of a dry ice delivery stage according to a system embodiment of the present invention;

FIG. 2 is a sectional part view of the manifold arrangement illustrated in FIG. 1;

FIG. 3 is a longitudinal sectional view of a dry ice charging stem such as that illustrated in FIG. 1 and with a drinking vessel received thereon;

FIG. 4 is an exploded view of a portion of FIG. 3 in the region of a dry ice chamber wall of the drinking vessel;

FIG. 5 is an end view of the drinking vessel and charging stem of FIG. 3 and shown in the direction of arrow A;

FIG. 6 is a sectional view of the jet nozzle as employed within the charging stem and as illustrated in FIG. 3;

FIG. 7 is a longitudinal sectional view of the delivery pipe of a charging stem of the present invention such as that illustrated in FIG. 3;

FIG. 8 is a view of dry ice dispensing apparatus employing the delivery stems such as illustrated in FIG. 1 and with its cover open; and

FIG. 9 is a view of the apparatus of FIG. 8 but with its cover closed.

### DETAILED DESCRIPTION OF THE EMBODIMENTS

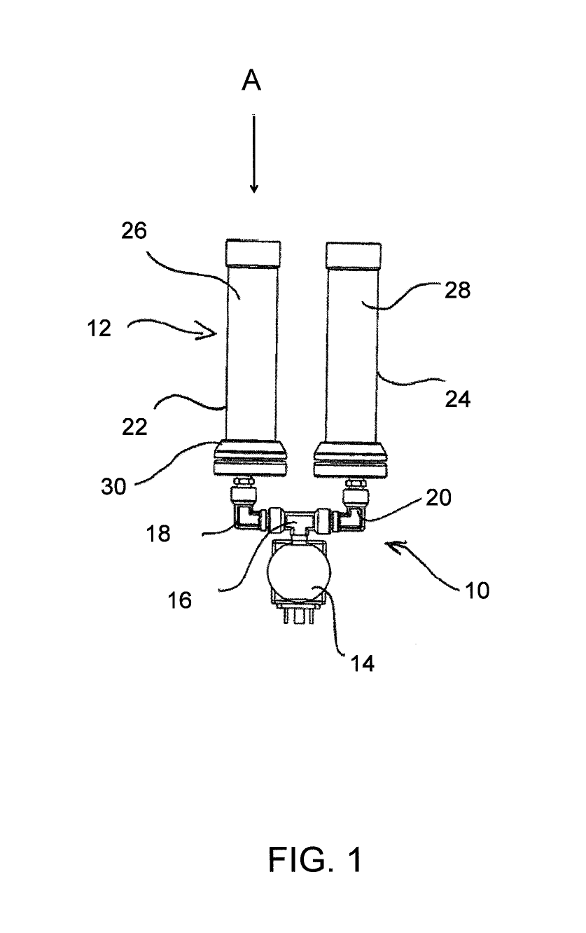

Turning first to FIG. 1, there is provided an illustration of dry ice delivery apparatus for use within a system of the present invention and comprising a manifold region 10 arranged to receive liquid carbon dioxide from a high pressure source, and a dry ice delivery end 12 arranged to receive the liquid carbon dioxide from the manifold region 10 and allow for the creation of carbon dioxide gas, and subsequent delivery of carbon dioxide gas and solid carbon dioxide (dry ice) as required in to a receptacle such as a drinking vessel.

The manifold region 10 comprises a valve connector for receiving liquid carbon dioxide from a common high pressurized source and, downstream of the valve 14, and a splitter 16 serving to divide the path for liquid carbon dioxide evenly between two manifold branches 18, 20.

The manifold branches 18, 20 feed into respective dry ice charging stems 22, 24 each of which includes a cylindrical outer wall 26, 28.

As will be appreciated from the following discussion, each of the charging stems 22, 24 is arranged to have an inverted drinking vessel seated thereon and having been positioned though downward movement of the vessel in the direction of arrow A of FIG. 1.

At the base of each of the charging stems 22, 24 is provided an outwardly extending annular shoulder 30 upon which the rim of a drinking vessel sits during the charging operation as is discussed further below.

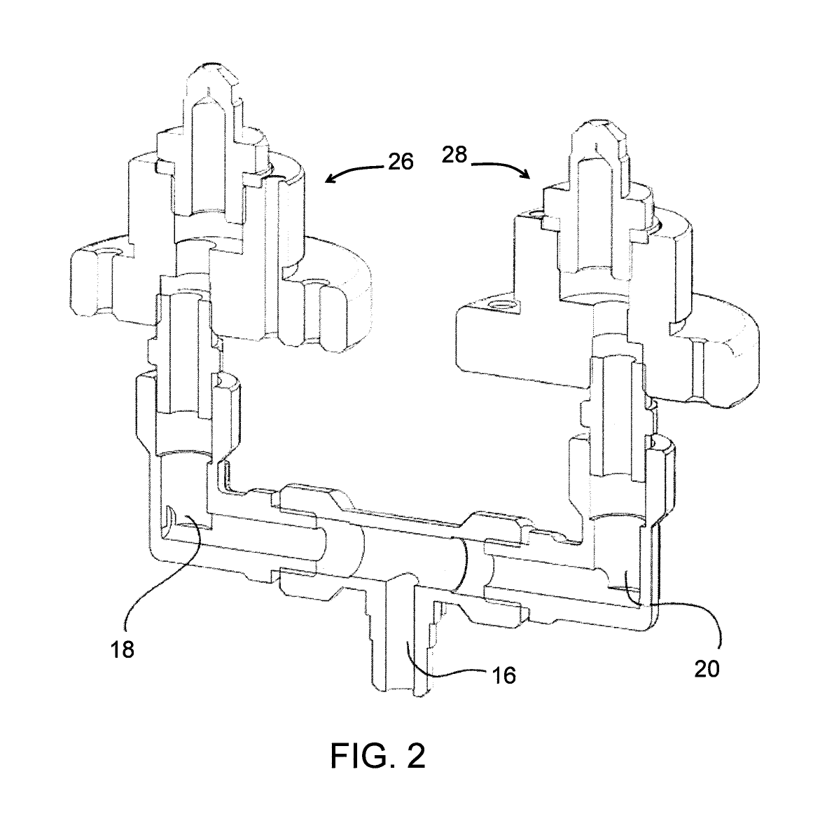

Turning now to FIG. 2, there is provided a part cutaway sectional view of the splitter 16 and the two manifold branches 18, 20.

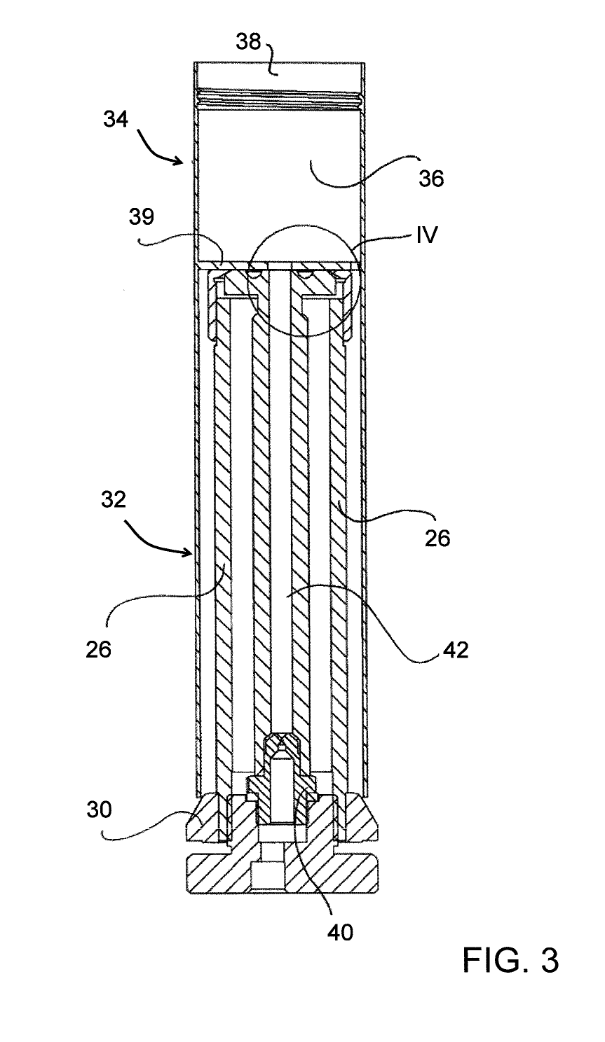

With regard to FIG. 3, further detail of one 26 of the charging stems illustrated in FIG. 1 is provided.

A long thin cylindrical drinking vessel 32 has been inverted and inserted over the charging stem 22 in the direction of arrow A as noted previously and as also noted, the rim sits on the annular shoulder 30.

The drinking vessel 32 includes a base portion 34 within which there is provided a dry ice chamber 36 which is enclosed at one end by a circular threaded closure member 38. The wall of the chamber 36 opposite that defined by the closure member 38 is formed by a separator 40 which serves to separate the dry ice chamber 36 from the remainder of the drinking vessel. The separator however includes a plurality of openings or perforations which allow for fluid communication between the chamber 36 and the reminder of the vessel 32.

Located coaxially with the outer wall 26 of the charging stem 22 is a jet nozzle 40 inserted in one end of an elongated delivery tube 42 and which extends from the jet nozzle 40 along the length of the charging stem 22 to cooperate with the separator 40.

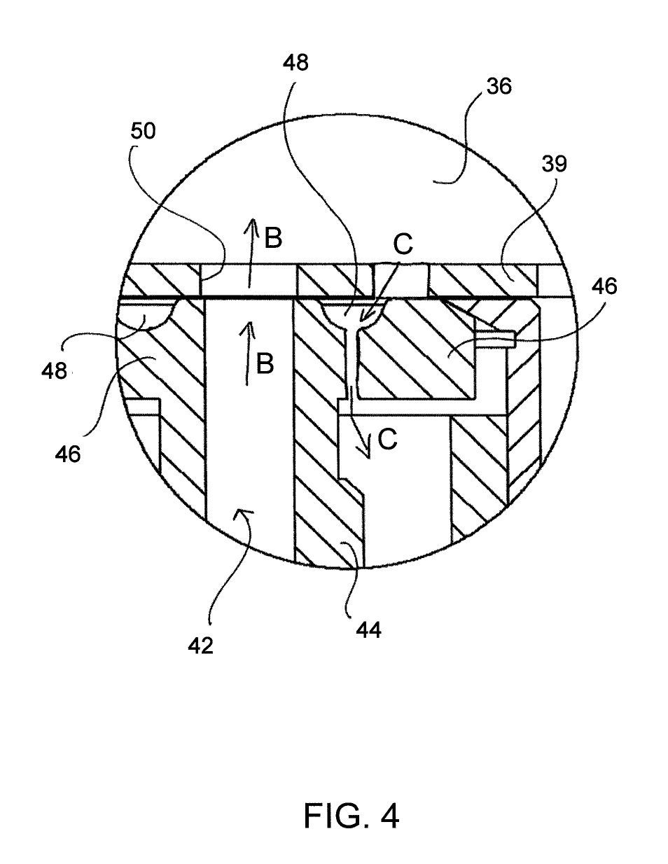

In particular, the elongate delivery tube 42 is arranged to be in communication with one of openings/perforations, generally located centrally, 50 of the separator 40 as will be described with further reference to FIG. 4.

FIG. 4 represents an enlarged view of a region of the interface between the charging stem 22 of FIG. 3 and the separator 40 and shows in further detail the central bore of the delivery tube 42 bounded by a cylindrical wall 44.

During the dry ice dispensing procedure, a mixture of dry ice “snow” and carbon dioxide gas travels along the bore of the delivery tube 42 in the direction of arrow B and through the central aperture 50 of the separator 40 into the dry ice chamber 36. Of course, as dry ice and carbon dioxide gas is delivered in the direction of Arrows B into the dry ice chamber 36, the pressure in the chamber 36 will start to build. This pressure is relieved by means of a pressure-relief path defined by a diffuser array 46 associated with a delivery end of the delivery tube 42 and which presents passages, including an opening 48, for communication with one of the apertures in the separator 40 so as to allow for an escape path indicated by Arrows C for carbon dioxide gas from the dry ice chamber 36.

The diffuser can advantageously be formed of plastic or other non-metallic or generally non-corrosive material.

The dimensions and form of the aperture 48 and venting passages, and their cooperation with the apertures within the separator 40 are advantageously employed so as to regulate the pressure maintained within the dry ice chamber 36 and provide for efficient production of dry ice therein both within a predefined period, and with regard to a particular quantity of source carbon dioxide.

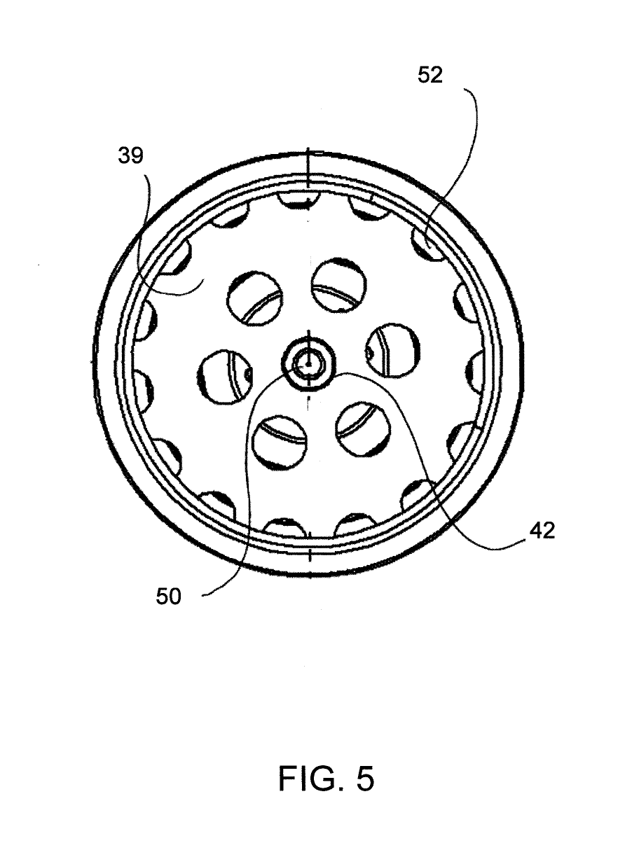

The particular configuration of the separator 40 illustrated in FIGS. 3 and 4 is shown further with reference to FIG. 5 which represents an end view of the arrangement of FIG. 3 and

FIG. 4 as is shown in the directions of arrows A and D respectively.

The generally circular form of the separator 40 is clearly shown in FIG. 5 as are the configurations of circular apertures provided generally evenly around the central opening of the separator therein, and outer segmented apertures 52 around the periphery of the separator 40. FIG. 5 also illustrates the opening of the delivery tube 42 into the dry ice chamber 36.

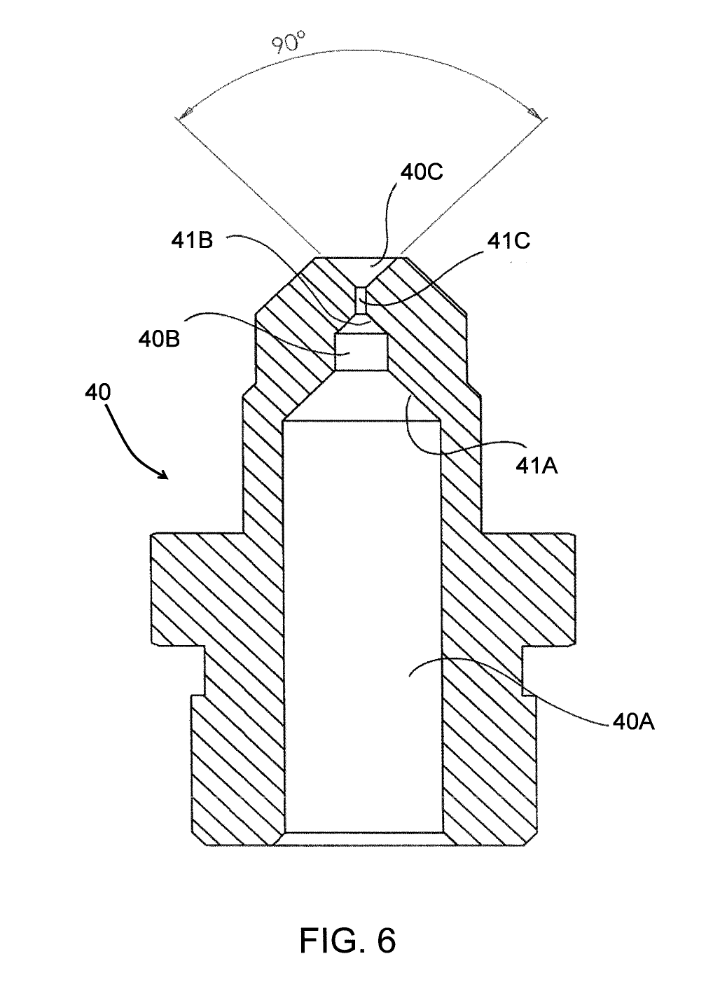

Turning now to FIG. 6, there is provided a sectional view of the jet nozzle 40 illustrated with reference to FIG. 5.

As will be appreciated, the jet nozzle 40 is configured so as to allow for an appropriate controlled release of pressure of the liquid carbon dioxide so as to form carbon dioxide gas at an appropriate rate serving further to provide for efficient creation of dry ice for delivery by way of the delivery tube 42 with which the jet nozzle is in communication.

In the illustrated embodiment, the jet nozzle 40 has a passageway extending along the length thereof though which liquid carbon dioxide travels from a high pressurized source (not shown) and in a so-called “direction of travel”.

The illustrated embodiment of FIG. 6 configures the passageway with two compression chambers 40A, 40B located in fluid communication and in series in the aforementioned direction of travel, and also an expansion portion 40C likewise and in fluid communication with the second compression chamber 40B.

Thus, the aforementioned direction of travel through the jet nozzle 40 is through the chambers/region 40A, 40B, 40C.

In a particular advantageous manner, the two compression chambers 40A, 40B serve to provide for a two-stage increase in liquid carbon dioxide (not shown) within the nozzle 40.

The internal dimensions of the first compression chamber 40A and also a transition portion 41A between the first compression chamber 40A and the second compression chamber 40B serve to increase the pressure of the liquid carbon dioxide within the nozzle to a first level above that of the supply source.

As clear from the illustrated embodiment, the transition portion 41A can be defined by way of a sloped inner wall surface of the passageway wherein the wall portion is provided at an angle of inclination relative to the direction of travel of the carbon dioxide.

In the manner illustrated, the inclined wall portion configures the internal wall of the transition region 41A as a frusto-conical internal wall portion.

The further, downstream compression chamber 40B is dimensioned so as to provide for a further, and second-stage, increase in pressure of the liquid carbon dioxide to a level above that within the first compression chamber 40A.

As illustrated, the second compressional chamber 40B can comprise a cylindrical bore surface extending from the downstream end of the frusto-conical transition region 41A and which itself, terminates at an upstream region in a transition portion 41B.

Again in the illustrated example, the transition portion 41B comprises a frusto-conical portion with planar internal wall portions at an angle inclined to the direction of travel of the carbon dioxide.

The liquid carbon dioxide travelling through the jet nozzle 40 therefore arrives at the exit of the second compression 40B at an advantageously, and controlled, high pressure level before being delivered, by way of a narrow bore 41C to the expansion portion 40C.

In the illustrated example, the expansion portion 40C effectively forms an outer flaring of the narrow bore 41 C which therefore, in the illustrated example, forms a frusto-conical inner wall of the expansion portion 40C.

The walls of the frusto-conical portion of the expansion region 40C generally stand out at an angle of inclination relative to the direction of travel of the liquid carbon dioxide through the jet nozzle, and thus in the illustrated example the central axis of each of the compression chambers 40A, 40B and the narrow ball 41C at an angle at, in the region of 45 degrees.

The opposite walls of the frusto-conical portion of the expansion region 40C are therefore at a mutual angle of, in the region of, 90 degrees.

The jet nozzle 40 can proved advantageous through the employment of the particular relative configuration/dimensions of the compression chambers and the expansion region and through the provision of the frusto-conical internal wall portions which, in relation to the compression chambers 40A, 40B comprise narrowing conical portions in the direction of travel of the carbon dioxide, whereas for the expansion region 40C comprise widening conical wall portions in the said direction of travel.

The controlled increase in pressure within the compression chambers of the jet nozzle 40, and then the subsequent controlled reduction in pressure allowed by way of the expansion region 40C proves advantageous in providing a controlled transition of the carbon dioxide from its liquid phase to its gaseous phase and in the manner to deliver the appropriate amount/mixture of carbon dioxide gas and liquid carbon dioxide downstream of the jet nozzle 40.

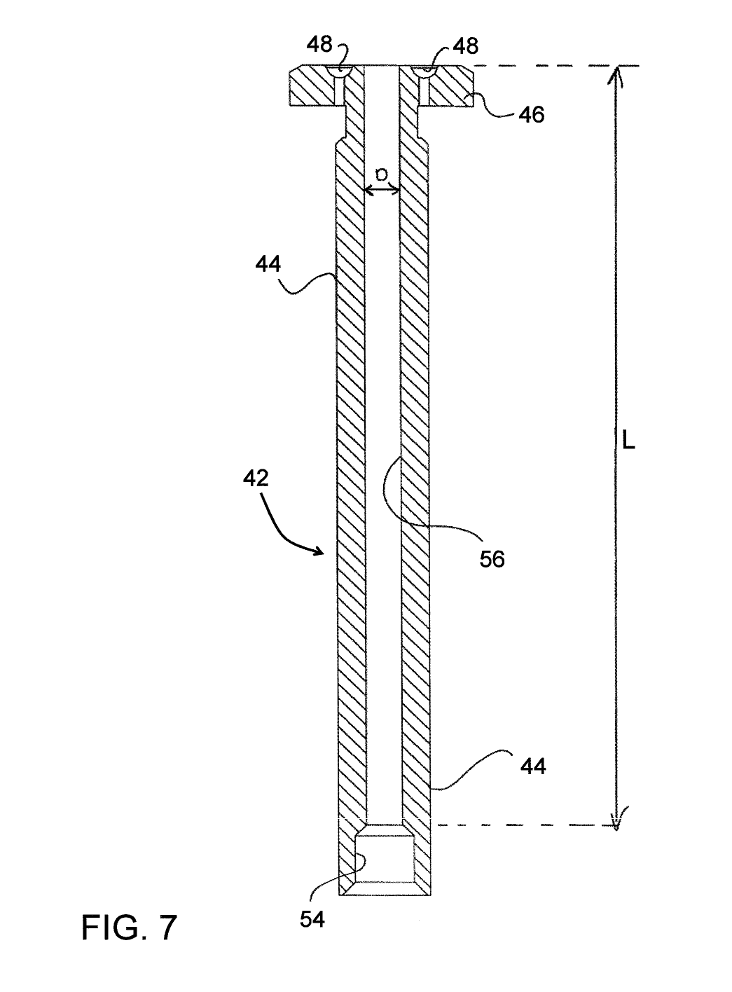

Further detail of the cylindrical delivery tube 42 is provided with reference to FIG. 7 and which illustrates the cylindrical walls 44, and diffuser array 46 as discussed in relation to FIG. 4.

At the end of the delivery tube 42 remote from the diffuser array 48, there is provided a stepped bore 54 configured to receive the injector jet nozzle 40 of FIG. 6. Again, the configuration of the delivery tube 42, and in particular the central bore thereof, is such as to provide for the efficient creation of dry ice “snow” as the pressure of the liquid carbon dioxide is relieved during its passage through and out of the jet nozzle 40 so as to produce, at a required rate and a required amount of dry ice “snow” as the temperature within the wall of the delivery tube 42 drops during the vaporization of the liquid carbon dioxide. As illustrated in this example, the delivery tube 42 can have an internal elongate bore 56 having a major portion downstream of the nozzle and which is of constant diameter.

It should be appreciated, that the diffuser array 46 can be formed as a separate element and arranged to cooperate with, or be mounted on, or in relation to, the delivery tube 42.

If preferred, the diffuser array 46 and delivery tube 42 can be formed integrally as a single element and, as a particular advantage, formed integrally as a single element of a, non-corrosive material such as, for example, plastic.

The important dimensions of width/diameter D and length L of the elongate uniform bore 56 are shown, and which in combination can be arranged to achieve delivery of dry ice having an appropriate density/consistency for use with beverages for “smoking effects”.

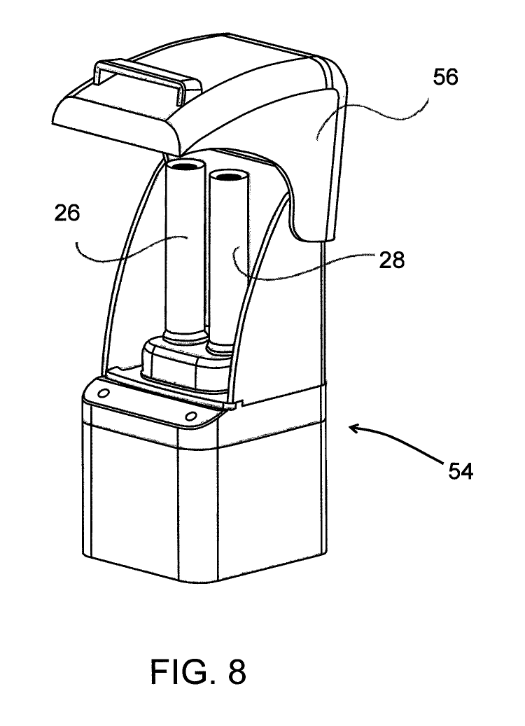

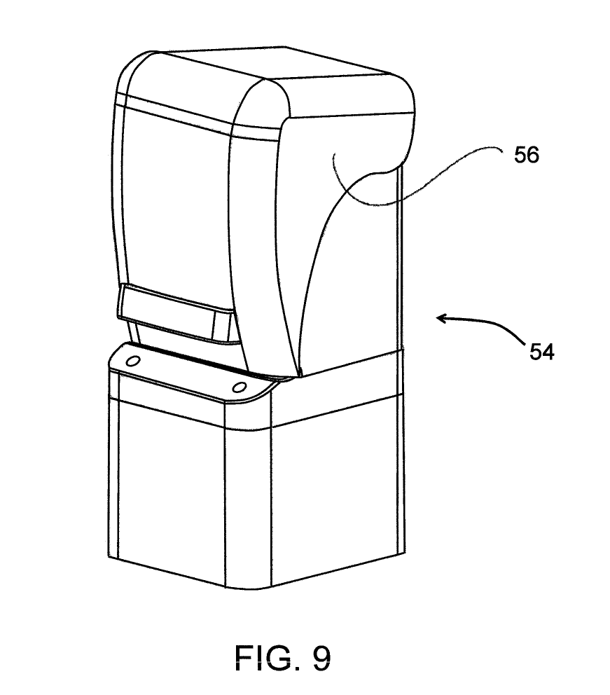

Finally, turning to FIGS. 8 and 9, there is illustrated a representation of a complete dry ice dispensing apparatus 54, including a pivotal lid, 56 according to and arranged for operation with an embodiment of the present invention.

In FIG. 8, the apparatus 54 is shown with its lid 56 pivoted upwardly towards a fully open position so as to allow access to the two charging stems 26, 28. In use, receptacles such as drinking vessels having compartments to be charged with dry-ice are lowered upside down onto the stems 26, 28 as noted previously.

Once the inverted drinking vessels are sat on the stems 26, 28, the lid can be closed for initiation of a dry-ice charging operation.

The illustrated embodiment employs the specifically designed injector nozzle 40 that has been designed to convert the liquid phase into a gas phase by on the basis of compression and rapid expansion principles. The injector is employed in combination with the transfer/delivery tube 42 which in the illustrated example has an integral diffuser 46 serving as a back-pressure control means to maintain the pressure in dry ice chamber during dry ice delivery. The new system does not suffer from corrosion and advantageously is not prone to blockage. Other advantages of the invention are that it can be readily manufactured from plastic, and can be dismantled in the event of contamination getting into the system and blocking the jet nozzle 40.

Safety and/or anti-misuse features can be included in the system to ensure the safety of the operator. A particular configuration of the new system comprises a sealed system, whereby the system will not function until the lid of the system has been closed ensuring the operation of the system is carried out in a confined space, the new system also uses electronic timer's to control the amount CO2 being used. If the operator misuses the system, it has been designed to slightly open the lid of the system therefore closing down any operation taking place, this is achieved with the use of a magnet in the lid and a HALL switch in the main system. If the operator charges up a glass too many times the ice build-up in the system pushes the glass upwards therefore raising the lid slightly.

For completeness, and merely to further illustrate one example of the invention, one possible delivery cycle is now discussed. Liquid to gas phase is carried out in the main injector nozzle 40. The gas phase is maintained in the delivery tube 24 and at the end of this tube the gas phase is allowed to expand even more as it enters the dry ice chamber 36 of the glass 32. Such further expansion leads to further cooling which enhances the formation of ice dry Ice crystals in the chamber 36, which then starts to fill with the required dry ice (not illustrated). A back pressure is required to ensure the dry ice is made only in the chamber 36 otherwise the dry ice will not form in the correct place.

The new system has been designed to optimise the back pressure in chamber 36 and to eliminate the blocking or stopping of the gas phase from leaving chamber 36 in a controlled manner, as the gas phase fills the chamber with dry ice, the pressure will build up and try to leave the chamber 36. The new system employs a diffuser array 46 provided at the end of the delivery tube 42, and arranged to seek, and maintain, optimum back-pressure in the chamber 36. This is controlled by the number/configuration of apertures/openings/holes/passages through the diffuser. These holes have been calculated in order to fill the chamber 36 with the correct density/amount of the dry ice. The gas that is allowed to vent will exit the system by the holes. The material used in the transfer/diffuser tube can be a plastic that can withstand the temperatures and pressure normally found in the system.

1. A dry-ice supply nozzle arranged to receive liquid carbon dioxide at an inlet and to apply a decrease in pressure to the liquid carbon dioxide for delivery of carbon dioxide gas at an outlet and for forming dry-ice, the said nozzle having a passageway extending from the inlet to the outlet and configured to increase the pressure of the liquid carbon dioxide received at the inlet prior to applying the said pressure decrease.

2. The nozzle as claimed in claim 1, wherein the passage includes a compression region for applying the said increase in pressure.

3. The nozzle as claimed in claim 1, wherein the passage is configured so as to provide a two stage increase in pressure of the liquid carbon dioxide.

4. The nozzle as claimed in claim 3, wherein the passage includes first and second compression regions in communication in series in a direction of travel of the carbon dioxide through the nozzle.

5. The nozzle as claimed in claim 4, wherein the second compression region has at least one dimension smaller than a corresponding dimension of the first compression region.

6. The nozzle as claimed in claim 5, wherein the said first and second compression regions comprise first and second cylindrical chambers in fluid communication.

7. A dry-ice delivery tube arranged to receive carbon dioxide gas and liquid carbon dioxide from a dry-ice delivery nozzle and having an elongate passageway configured to at least part-control formation of a carbon dioxide gas phase and for controlled formation of dry-ice within the tube.

8. The delivery tube as claimed in claim 7, and arranged such that the dry-ice is to be formed towards an end of the tube arranged to be remote from the said delivery nozzle.

9. The delivery tube as claimed in claim 7, and including an outlet arranged for delivering dry-ice into a target receptacle.

10. A dry-ice delivery diffuser having a delivery aperture through which carbon dioxide gas and dry ice can be delivered to a target receptacle from a delivery tube, and the diffuser having venting apertures dimensioned to control escape of carbon dioxide gas from the target receptacle, and thus to control the pressure within the target receptacle.

11. The diffuser as claimed in claim 10, wherein the said the venting apertures are arranged to cooperate with apertures formed in a wall portion of the target receptacles.

12. The diffuser as claimed in claim 10, wherein the said venting apertures comprise a first series of apertures located around the said delivery aperture.

13. A method of supplying dry-ice to a target receptacle and including the steps of receiving liquid carbon dioxide from a pressurized source, increasing the pressure of the liquid carbon dioxide prior to the step of decreasing the pressure thereof and for the transition of liquid carbon dioxide to carbon dioxide gas and the subsequent formation of dry-ice.

14. The method as claimed in claim 13 wherein the step of increasing the pressure of the dry-ice comprises a two stage procedure with the pressure increasing from a first level to a second level, and then from the second level to a third level.

15. The method as claimed in claim 13, wherein the step of increasing the pressure includes delivery of the liquid carbon dioxide into, and travel along, a conduit of decreasing dimension in the direction of flow of the carbon dioxide through the conduit.
